(19) United States
(12) Patent Application Publication
(10) Pub. No.: US 2010/0144185 A1
(43) Pub. Date: Jun. 10, 2010

(54) PLUG-AND-SOCKET CONNECTOR

(76) Inventor: Yurij Donetsky, Moscow Region (RU)

Correspondence Address: Aleksandr Smushkovich, POB 140505, Brooklyn, NY, 11214, US

(21) Appl. No.: 12/450,235

(22) PCT Filed: Jul. 10, 2008
(86) PCT No.: PCT/RU2008/000451

§ 371 Date: Sep. 17, 2009

(30) Foreign Application Priority Data
Aug. 17, 2007 (RU) 2007131372

(51) Int. Cl. H01R 13/635

(52) U.S. Cl. 439/262

(57) ABSTRACT

An electric device, called ‘plug-and-socket connector’ is proposed that can be used for simplifying the disconnection of a plug from a socket of an electric grid. The inventive plug-and-socket connector comprises a socket, a plug with an electric cable, an arm provided with an electric cable holder, and a plug pusher. The arm is mounted on the socket in such a way as to interact with the plug pusher with the aid of the electric cable's tension force. The electric cable holder can be designed in the form of a slider displaceable along the arm.

### CROSS-REFERENCES TO RELATED APPLICATIONS

This application is a U.S. national phase application of a PCT application PCT/RU2008/000451 filed on 10 May 2008, published as WO2009/031928, whose disclosure is incorporated herein in its entirety by reference, which PCT application claims priority of a Russian Federation patent application RU2007131372 filed on 17 Aug. 2007.

### FIELD OF THE INVENTION

This invention belongs to the field of electrical engineering. It can be used to connect power supply to electrical devices that require plug-and-socket connections, which can be easily disconnected when the electric cable is accidentally pulled with a force exceeding the maximum allowable force.

### BACKGROUND OF THE INVENTION

The widest sphere of application for this invention is plug-and-socket connections at residential and industrial premises. With the evolution of electrical and electronic equipment, modern residential and industrial premises have become filled with a large number of electrical and electronic devices connected by electric cables via plug-and-socket connections between themselves or with the building's power grid. The large number of wires raises the risk that a moving person or object can catch on an electrical wire, causing the person or equipment to fall, sustaining injuries or causing damage to equipment or the power grid.

A magnetic connector for laptop electric cables (MagSafe) has been widely used recently. It enables the electric cable to be easily disconnected when pulled accidentally. In this connection, the socket supplying power to the laptop retains the mating end of the plug-and-socket connection at the end of the electric cable. The force of the electric cable being pulled accidentally exceeds the force of magnetic attraction, and the electric cable is disconnected from the laptop. The electric cable remains connected to the power grid. The force of attraction between the plug-and-socket connection contacts should be small. These are minor drawbacks for low-voltage power supply of laptops. Meanwhile, these shortcomings make it impossible to use the abovementioned device with equipment powered by the industrial or household power grid with a high voltage that posses, a health hazard and calls for higher quality of contacts. A greater force will be required to separate such a connection.

Prior art discloses a socket with plug ejection devices (patent HU 208882), which has been chosen as a prototype (the nearest prior art device) for this invention. It comprises a pusher in the form of a double-arm lever. When one arm is pressed, the other arm ejects the plug from the socket via a tappet with a push button. In this design, the plug is extracted from the socket not by the pulling force of the hand, but by the ejection force transmitted from the hand via the button to the plug pusher. This design minimizes the risk of damage to plug-and-socket connection elements during operation. This makes it impossible to dislodge the socket from the wall or damage electric cable contacts with the plug contact pins. However, this design is not intended for easy disconnection when the electric cable is pulled accidentally.

### BRIEF DESCRIPTION OF THE INVENTION

The technical result of the invention is the possibility of easy disconnection of the plug from the socket when the electric cable tension exceeds the maximum allowable force, which is created when the electric cable is pulled accidentally.

The technical result is achieved by an arm furnished with a holder of an electric cable, and the holder is mounted on the socket. The arm is installed in such a way that it interacts with a plug pusher when the electric cable is pulled.

The holder can be made in the form of a slider that can move along the arm.

### BRIEF DESCRIPTION OF DRAWINGS

FIG. 1 shows a side view of a connected plug-and-socket connector, according to an embodiment of the present invention.

FIG. 2 shows a side view of a disconnected plug-and-socket connector, according to the embodiment of the present invention shown on FIG. 1.

### DETAIL DESCRIPTION OF A PREFERRED EMBODIMENT

While the invention may be susceptible to embodiment in different forms, there is shown in the drawings, and will be described in detail herein, a specific embodiment of the present invention, with the understanding that the present disclosure is to be considered an exemplification of the principles of the invention, and is not intended to limit the invention to that as illustrated and described herein.

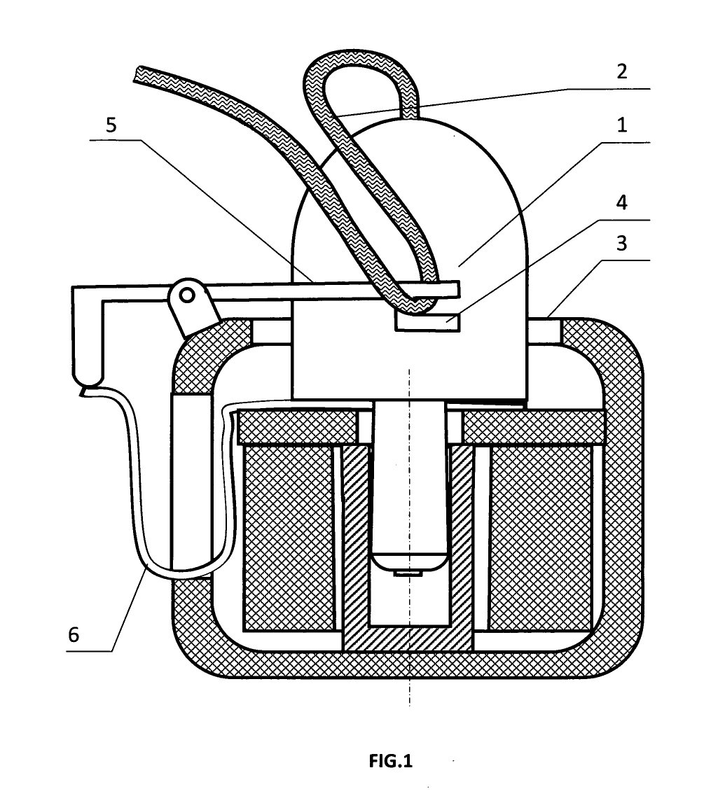

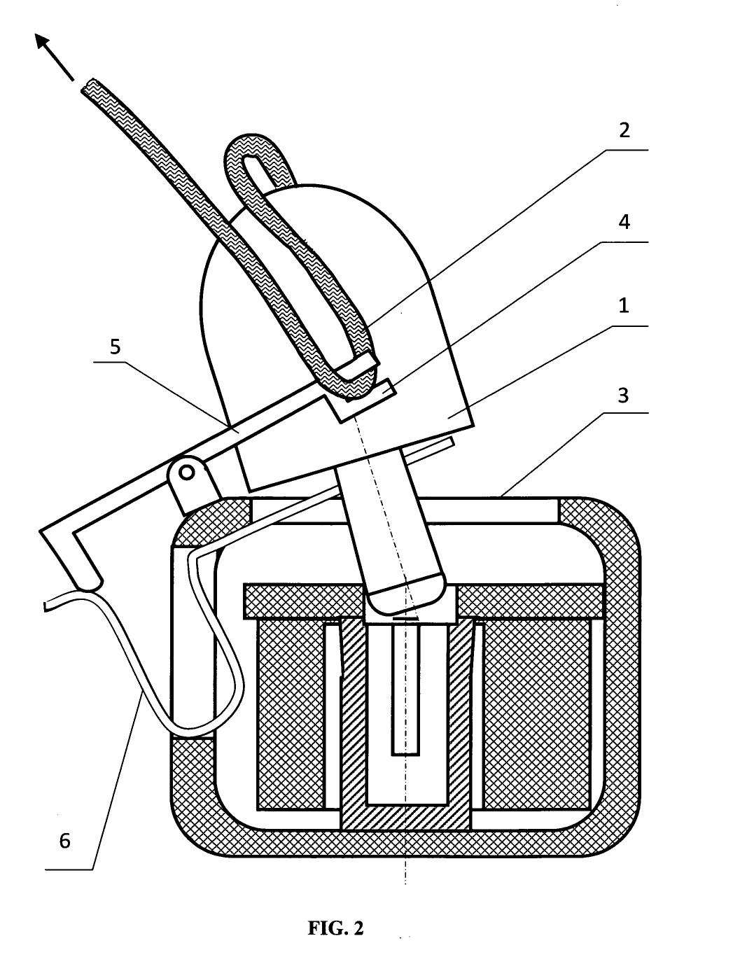

A preferred embodiment of the inventive plug-and-socket connector is illustrated on FIGS. 1 and 2. The plug-and-socket connector comprises: a socket (3); an electric plug (1) joined with an electric cord (2), the plug (1) is insertable into the socket (3); an arm (5) furnished with a cord holder (4); and a plug pusher (6) secured in the socket (3); when the plug is inserted into the socket (3) the pusher (6) is in touch with the arm (5), the pusher (6) is so configured that allows ejecting the plug (1) from the socket (3) while being depressed by the arm (5). The cord (2) passes via the cord holder (4) of the arm (5).

The holder can be made in the form of a slider displaceable along the arm, which will make it possible to adjust the allowable cord tension.

When the cord (2) is pulled accidentally in the direction indicated by the arrow (FIG. 2), a force of cable tension is applied to the arm (5) that enables the arm to actuate the plug pusher (6), which ejects the plug (1) from the socket (3). After the plug has been ejected, the arm (5) and pusher (6) return to their initial positions.

Therefore, the proposed plug-and-socket connector enables easy disconnection of the plug from the socket when the electric cable is accidentally pulled with a force that exceeds the maximum permissible force, preventing the person or equipment from falling and sustaining injuries or causing damage to equipment or the power grid.

1. A plug-and-socket connection comprising:
an electric socket;
an electric plug insertable into said socket;
an electric cord joined with said plug;
an arm mounted on said socket, said arm is furnished with a cord holder so configured that said cord passes via said holder; and
a plug pusher secured in said socket, said pusher is so configured that allows ejecting said plug from said socket, upon being depressed by said arm.

2. The plug-and-socket connection according to claim 1, wherein, when said plug is inserted into said socket, said pusher is being in touch with said arm.
